(19) United States
(12) Patent Application Publication
(10) Pub. No.: US 2009/0153530 A1
(43) Pub. Date: Jun. 18, 2009

(54) ACTIVE DEVICE ARRAY SUBSTRATE AND METHOD FOR DRIVING THE SAME

(75) Inventors: Fei-Shun Chen, Hsinchu (TW); Lu-Kuen Chang, Hsinchu (TW); Chia-Yen Hsu, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: AU OPTRONICS CORPORATION, Hsinchu (TW)

(21) Appl. No.: 12/046,474

(22) Filed: Mar. 12, 2008

(30) Foreign Application Priority Data
Dec. 17, 2007 (TW) 96148202

(51) Int. Cl. G06F 3/038

(52) U.S. Cl. 345/204

(57) ABSTRACT

An active device array substrate having a display area and a circuit area connected thereto is provided. The active device array substrate includes scan lines, data lines intersecting the scan lines, pixel units, scan-signal terminals, transmission circuit sets, controlling lines and controlling switches. The pixel units are located in the display area and electrically connect the corresponding scan lines and data lines. The scan-signal terminals, the transmission circuit sets, the controlling lines and the controlling switches are located in the circuit area. Each of the transmission circuit set is respectively connected to a corresponding scan-signal terminal. Each transmission circuit set includes transmission lines corresponding to the scan lines. The controlling lines intersect the transmission lines and the controlling switches are connected to the transmission lines, respectively. The controlling switches connected to the same scan-signal terminals are connected to different controlling lines.

### CROSS-REFERENCE TO RELATED APPLICATION

This application claims the priority benefit of Taiwan application serial no. 96148202, filed on Dec. 17, 2007. The entirety the above-mentioned patent application is hereby incorporated by reference herein and made a part of specification.

### BACKGROUND OF THE INVENTION

1. Field of the Invention

The present invention relates to an active device array substrate and a method for driving the same, and more particular to a more cost-effective active device array substrate and a driving method thereof.

2. Description of Related Art

As LCD panels continuously adopt larger display specification, the viewing angle width of an LCD panel gradually becomes an important factor when users purchase relevant display products. In order to overcome the display viewing angle problem of the LCD panels, the technique of wide viewing angle must keep on advancing and developing. Currently, technologies which can fulfill the demand of wide viewing angles include twisted nematic (TN) liquid crystals with wide viewing films, in-plane switching (IPS) LCDs, fringe field switching (FFS) LCDs, and multi-domain vertical alignment (MVA) LCDs.

Generally, the above-mentioned wide viewing angle technologies enable LCD panels to have a wider display viewing angle. Yet, due to the optical properties of the liquid crystal molecules, when viewing an image shown by the LCD panel at a large viewing angle, color washout may occur. To mitigate such phenomenon, a method has been proposed to form a plurality of areas with different display grey levels in a single pixel unit through improving driving principles and pixel designs. The method is mainly performed by further disposing another set of active device and pixel electrodes connected to another scan signal in one pixel to compensate for the color washout.

However, disposing a plurality of active devices in one pixel unit requires increasing the number of driving chips used on the active device array substrate and thus causes the manufacturing cost to rise. In addition, increasing the number of chips used means more complex circuit design and cause problem in space utilization.

### SUMMARY OF THE INVENTION

The present invention provides an active device array substrate to solve the problem of higher manufacturing cost due to the number of driving chips used.

The present invention is directed to another driving method provided to reduce the number of driving chips required.

The present invention provides an active device array substrate having a display area and a circuit area connected to the display area. The active device array substrate includes a plurality of scan lines, a plurality of data lines, a plurality of pixel units, a plurality of scan-signal terminals, a plurality of transmission circuit sets, a plurality of controlling lines and a plurality of controlling switches. The data lines intersect the scan lines. The pixel units are located in the display area and electrically connected to the corresponding scan lines and data lines. The scan-signal terminals, the transmission circuit sets, the controlling lines and the controlling switches are all located in the circuit area. Each transmission circuit set is connected respectively to the corresponding scan-signal terminal, and each transmission circuit set includes a plurality of transmission lines corresponding to the scan lines. The controlling lines intersect the transmission lines and the controlling switches connect the transmission lines, respectively. The controlling switches connected to the same scan-signal terminals are connect to different controlling lines.

In one embodiment of the present invention, the pixel unit includes a plurality of first active devices and a plurality of first pixel electrodes electrically connected thereto. The first active devices electrically connect one of the corresponding data lines and electrically connect different scan lines respectively. The scan lines electrically connect each pixel unit via, for example, corresponding controlling switches electrically connected to the same scan-signal terminal. Each pixel unit further includes a plurality of second active devices and a plurality of second pixel electrodes electrically connected thereto. In addition, each second active device and the first active device corresponding thereto are disposed on the same scan line and the second active device is electrically coupled to the corresponding first active devices.

In one embodiment of the present invention, the active device array substrate further includes a plurality of common lines intersecting the pixel units.

In one embodiment of the present invention, the transmission circuit set includes a first transmission circuit set and a second transmission circuit set, wherein a number of the transmission lines in the first transmission circuit set equal to a number of the transmission lines in the second transmission circuit set. In practice, the number of the transmission lines of each of the transmission circuit set is, for example, 2, 3 or 4.

In one embodiment of the present invention, the number of the transmission lines in each of the transmission circuit set can be 2, 3 or 4.

The present invention further provides a method for driving the above-mentioned active device array substrate. First, a plurality of controlling signals are provided to different controlling lines respectively in order to switch on the controlling switches located on different controlling lines. In addition, a scan signal is provided to the transmission circuit sets from the scan-signal terminal, and with the controlling switches being switched on, the scan signal is provided to different scan lines.

In one embodiment of the present invention, the controlling signals provided to different controlling lines are not synchronized.

In one embodiment of the present invention, a start-up time of the scan signal is later than a start-up time of one of the corresponding controlling signals.

In one embodiment of the present invention, an ending time of the scan signal is earlier than an ending time of one of the corresponding controlling signals.

In one embodiment of the present invention, the scan signal overlaps the controlling signals.

In one embodiment of the present invention, the frequency of the controlling signal is “f” and the frequency of the scan signals is “nf”, and n represents a number of the transmission lines of each of the transmission circuit sets.

In one embodiment of the present invention, the driving method further includes providing a plurality of data signals to the data lines respectively.

As the transmission circuit sets consisted of a plurality of transmission lines is connected to the same scan-signal terminal in the present invention, the signals provided from the scan-signal terminals can be provided to a plurality of transmission lines and scan lines. Meanwhile, each transmission line is connected to a controlling switch, so the signals provided from the scan-signal terminal can be provided to the corresponding scan lines at different points of time. In other words, in the active device array substrate of the present invention, the driving signals of a plurality of scan lines can be provided by the same driving chip so as to reduce the number of required driving chips to reduce the cost thereof.

In order to the make the aforementioned and other objects, features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates an active device array substrate according to the first embodiment of the present invention.

FIG. 2 is a timing diagram illustrating the driving method of the active device array substrate according to the first embodiment of the present invention.

FIG. 3 illustrates an active device array substrate according to the second embodiment of the present invention.

FIG. 4 illustrates an active device array substrate according to the third embodiment of the present invention.

FIG. 5 illustrates an active device array substrate according to the fourth embodiment of the present invention.

FIG. 6 illustrates an active device array substrate according to the fifth embodiment of the present invention.

FIG. 7 is a timing diagram illustrating the driving method of the active device array substrate according to the fifth embodiment of the present invention.

### DESCRIPTION OF EMBODIMENTS

### The First Embodiment

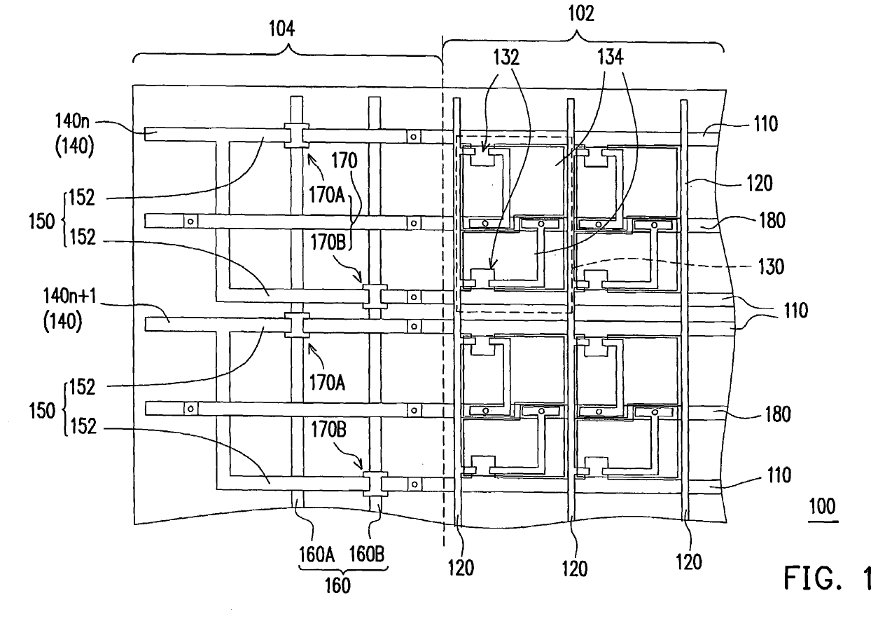

FIG. 1 illustrates an active device array substrate according to the first embodiment of the present invention. Referring to FIG. 1, an active device array substrate 100 has a display area 102 and a circuit area 104 connected thereto. The display area 102 is for displaying. The active device array substrate 100 includes a plurality of scan lines 110, a plurality of data lines 120, a plurality of pixel units 130, a plurality of scan-signal terminals 140, a plurality of transmission circuit sets 150, a plurality of controlling lines 160 and a plurality of controlling switches 170. The data lines 120 intersect the scan lines 110. The pixel units 130 are located in the display area 102 and are connected electrically to the corresponding data lines 120 and the scan lines 110. The scan-signal terminals 140, the transmission circuit sets 150, the controlling lines 160 and the controlling switches 170 are all located in the circuit area 104. In addition, the active device array substrate 100 further includes a plurality of common lines 180 which intersect the pixel units 130. When the pixel units 130 display an image, the capacitor effect provided by the common lines 110 helps maintain a displaying voltage of the pixel units 130.

Specifically, each transmission circuit set 150 is connected respectively to the corresponding scan-signal terminal 140 and each transmission circuit set 150 includes a plurality of transmission lines 152 connected to the scan lines 110. In addition, the controlling lines 160 intersect the transmission lines 152 and the controlling switches 170 are connected respectively to the transmission lines 152. The controlling switches 170 connected to the same scan-signal terminal 140 are connected to different controlling lines 160. In other words, each scan-signal terminal 140 is connected to a transmission circuit set 150, i.e. a plurality of transmission lines 152. In the mean time, each transmission line 152 in the same transmission circuit set 150 is connected to a different controlling switch 170. When one of the controlling switches 170A or 170B is switched on via a controlling line 160A or 160B, a signal provided by each scan-signal terminal 140 can be transmitted to a portion of the scan lines 110.

According to the present embodiment, the number of the transmission lines 152 of each transmission circuit set 150 is two, for example, so the signals provided from each scan-signal terminal 140 can be transmitted to two scan lines 110. In other words, every two scan lines 110 can be controlled by the signal provided from the same scan-signal terminal 140 and only one corresponding driving chip is required to be disposed. Therefore, the number of driving chips required for the active device array substrate 100 of the present embodiment is lessened and thereby helps to reduce the cost thereof.

In addition, each pixel unit 130 includes two active devices 132 and two pixel electrodes 134 electrically connected to the active devices 132. That is to say, the pixel units 130 can be roughly divided into two display areas. The active devices 132 electrically connect one of the corresponding data lines 120, but they are electrically connected to different scan lines 110 respectively. Each scan line 110 may be respectively connected to one of the transmission lines 152. The controlling switches being switched on or off determine whether the scan lines 110 are electrically connected to the corresponding scan-signal terminal 140. That is to say, the active devices 132 on the different scan lines 110 can be connected to the same scan-signal terminal 140, and controlled by the signals provided from the scan-signal terminal 140.

The same pixel unit 130 includes a plurality of active devices 132 and a plurality of pixel electrodes 134 so as to define a plurality of display areas displaying different brightness. It is known from the description of the prior art that, a design of a plurality of display areas helps alleviate the phenomenon of color washout when viewing an image displayed by an LCD panel at a large viewing angle. According to the present embodiment, the active devices 132 on at least two scan lines 110 can be controlled by the same scan-signal terminal 140, which further reduces the utility cost of driving chips. In addition, the circuit layout of the circuit area 104 can be more simplified because less driving chips are used. Certainly, the scan-signal terminal 140 is not confined to connect only two transmission lines 152. If the same scan-signal terminal 140 is connected to more than two transmission lines 152, the cost can be more effectively reduced.

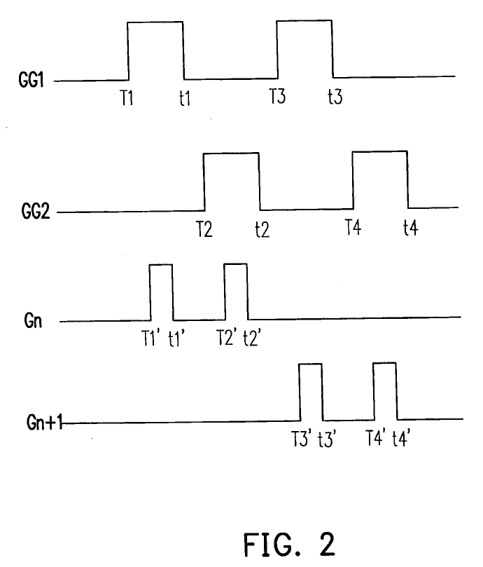

In the active device array substrate 100, the controlling switch 170 determines whether each transmission line 152 can transmit the signal to the corresponding scan line 110. In detail, a method for driving the active device array substrate 100 is described as below. FIG. 2 is a timing diagram illustrating the method for driving the active device array substrate according to the first embodiment of the present invention. Referring both FIGS. 1 and 2, the method for driving the active device array substrate 100 is, for example, providing a plurality of controlling signals GG1 and GG2 respectively to different controlling lines 160A and 160B. Meanwhile, a scan signals Gn and a scan signal Gn+1 are respectively provided to different transmission circuit sets 150 by scan-signal terminal 140n and scan-signal terminal 140n+1. Actually, the scan-signal terminals 140n and 140n+1 can be connected respectively to a driving chip (not illustrated) which provides the scan signal Gn and the scan signal Gn+1.

The controlling signal GG1 is provided to the controlling line 160A so as to switch on the controlling switches 170A and the controlling signal GG2 can switch on the controlling switches 170B. It is known from FIG. 2 that the controlling signals GG1 and GG2 are not synchronized and do not overlap with each other, so the controlling switches 170A and the controlling switches 170B are switched on at different points of time.

Further, start-up times T1′˜T4′ of the scan signal Gn and Gn+1 are respectively later than start-up times T1˜T4 of the corresponding controlling signals GG1 and GG2. Ending times t1′˜t4′ of the scan signals Gn and Gn+1 are earlier than ending times t1˜t4 of the corresponding controlling signals GG1 and GG2 respectively. In other words, each signal pulse of the scan signals Gn and Gn+1 overlap with that of the controlling signals GG1 and GG2 in time. Therefore, when the controlling switches 170 on the controlling lines 160 are switched on, each of the scan signals Gn and Gn+1 can be transmitted to the corresponding scan line 110.

In detail, when the controlling switch 170A is switched on during T1-t1, the scan signal Gn provided by the scan-signal terminal 140n can be transmitted to the corresponding scan lines 110. When the controlling switch 170A is switched off, the controlling switch 170B is switched on during T2˜t2 so as to transmit the scan signal Gn provided by the scan-signal terminal 140n to another scan line 110 during T2′˜t2′. Likewise, the controlling switch 170A which is switched on again during T3˜t3 enables the scan signal Gn+1 provided by the scan-signal terminal 140n+1 to be provided to the corresponding scan line 110. During T4˜t4, the switched-on controlling switch 170B enables the scan signal Gn+1 during T4′˜t4′ to be provided to another scan line 110. Therefore, by switching on the controlling switch 170 via the controlling line 160 in sequence, the transmission lines 152 connected to each controlling switch 170 are turned on so as to transmit the corresponding signals to each scan line 110.

In practice, at the same time when the scan line 110 is provided with the scan signals Gn and Gn+1, the data lines 120 can be provided with different data signals so as to enable the pixel units 130 to achieve a specific display voltage. Since the active devices 132 corresponding to different scan lines 110 are turned on in order, the data lines 120 can provide different data signal in order. Thus, the different pixel electrodes 134 in the same pixel unit 130 can achieve different display voltages respectively. Therefore, the application of active device array substrate 100 in the LCD panel helps alleviate the phenomenon of color washout when viewing an image at a large viewing angle.

Certainly, the pixel electrodes 134 can achieve different display voltages in different ways according to the present embodiment. For instance, the plurality of pixel electrodes 134 of each pixel unit 130 may overlap with common lines 180 on different areas, so as to constitute storage capacitors of different sizes. Thus, different pixel electrodes 134 can also have different display voltages.

The scan signals Gn, Gn+1 transmitted by each scan-signal terminal 140 can be provided to the transmission lines 150 and provided to different scan lines 110 in order. Therefore, if the frequency of the controlling signal GG1 and the controlling signal GG2 is “f”, the frequency of the scan signal Gn and scan signal Gn+1 is “nf”, and “n” represents a number of the scan lines 152 which are connected to each scan-signal terminal 140. According to the present embodiment, each transmission circuit set 150 connected to the same scan-signal terminal 140, for example, includes two transmission lines 152, so the frequency of the scan signals Gn and the scan signal Gn+1 is “2f”.

When the scan signals Gn and Gn+1 are coordinated with proper controlling signals GG1 and GG2, each scan-signal terminal 140 connecting a driving chip (not illustrated) can provide signals for the scan lines 110. Therefore, the active device array substrate 100 of the present embodiment helps decrease the number of driving chips required and reduces the cost thereof.

### The Second Embodiment

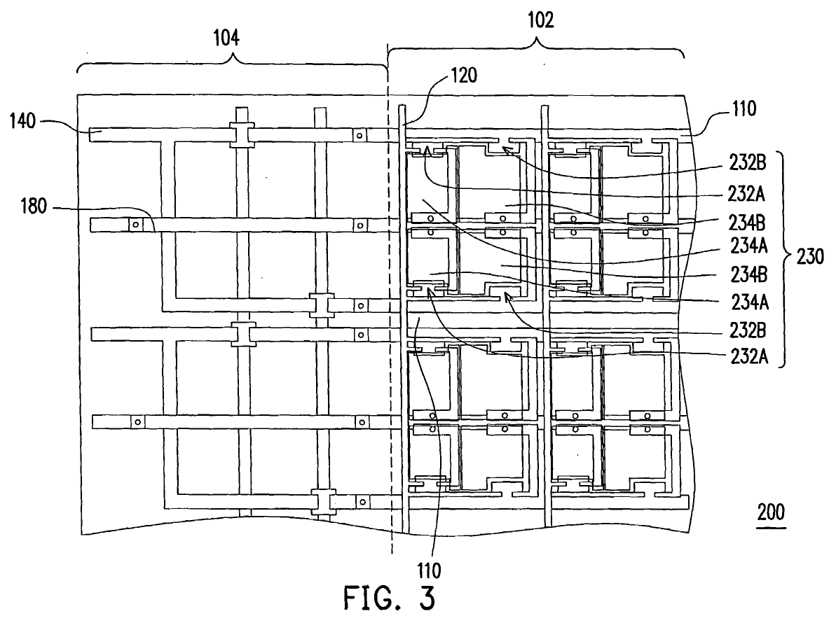

FIG. 3 illustrates an active device array substrate according to the second embodiment of the present invention. Referring to FIG. 3, an active device array substrate 200 is similar to the active device array substrate 100, wherein each pixel unit 230 includes two first active devices 232A and two second active devices 232B. Meanwhile, in the pixel unit 230, two first pixel electrodes 234A electrically connected with the first active device 232A and two second pixel electrodes 234B electrically connected with the second active device 232B are correspondingly disposed in the pixel unit 230. In other words, the pixel unit 230 is subsequently divided into four display areas. Each display area is constituted of an active device (232A or 232B) and a pixel electrode (234A or 234B). These first active devices 232A electrically connect one of the corresponding data lines 120, and electrically connect to different scan lines 110 respectively. In addition, each second active device 232B and the corresponding first active devices 232A are disposed on the same scan line 110 and each second active device 232B is electrically coupled to the corresponding first active device 232A.

In the present embodiment, the first active device 232A connected to different scan lines 110 can be controlled by the signal provided by the same scan-signal terminal 140. Therefore, the circuit design of the active device array substrate 200 helps reduce the cost by decreasing the number of driving chips required. In addition, the first active device 232A and the second active device 232B are electrically coupled and hence divide the pixel unit 230 into four display areas. Therefore, the application of the active device array substrate 200 in the LCD panels helps improve the display quality thereof. Certainly, the number of the disposed first active device 232A in each pixel unit 230 of the present embodiment may also be more than two, and more than two transmission lines 152 are disposed in each of the transmission circuit set 150.

### The Third Embodiment

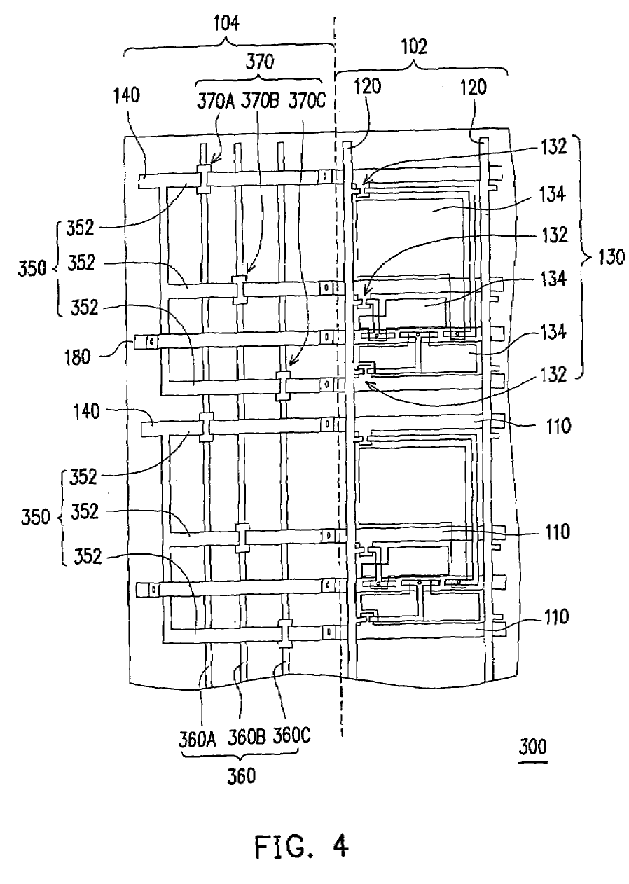

FIG. 4 illustrates an active device array substrate according to the third embodiment of the present invention. Referring to FIG. 4, the active device array substrate 300 is similar to the active device array substrate 100 of the first embodiment, wherein each transmission circuit set 350 includes three transmission lines 352. In other words, each scan-signal terminal 140 can provide scan signals for the three scan lines 110. Therefore, compared to other active device substrate with designs of the same resolution and the same size, the active device array substrate 300 requires less driving chips and thus reduces the manufacturing cost.

Actually, corresponding to the number of the transmission lines 352 in each transmission circuit set 350, the number of both controlling switches 370 and controlling lines 360 is three respectively. Each transmission line 352 correspondingly connects one of the controlling switches 370 and one of the controlling lines 360. Each pixel unit 130 can be disposed with three active devices 132 and three pixel electrodes 134 corresponding thereto. Namely, each of the pixel unit 130 can be divided into three display areas connected to different scan lines 110. When applying the active device array substrate 300 to LCD panels, each display area of the same pixel unit 130 can have a different display voltage so as to improve the display quality of the LCD panels. In addition, a driving method of the active device array substrate 300 is substantially the same as that of the active device array substrate 100, wherein the frequency of the scan signal provided into the scan-signal terminal 140 is three times the frequency of the controlling signal provided to the controlling line 360.

### The Fourth Embodiment

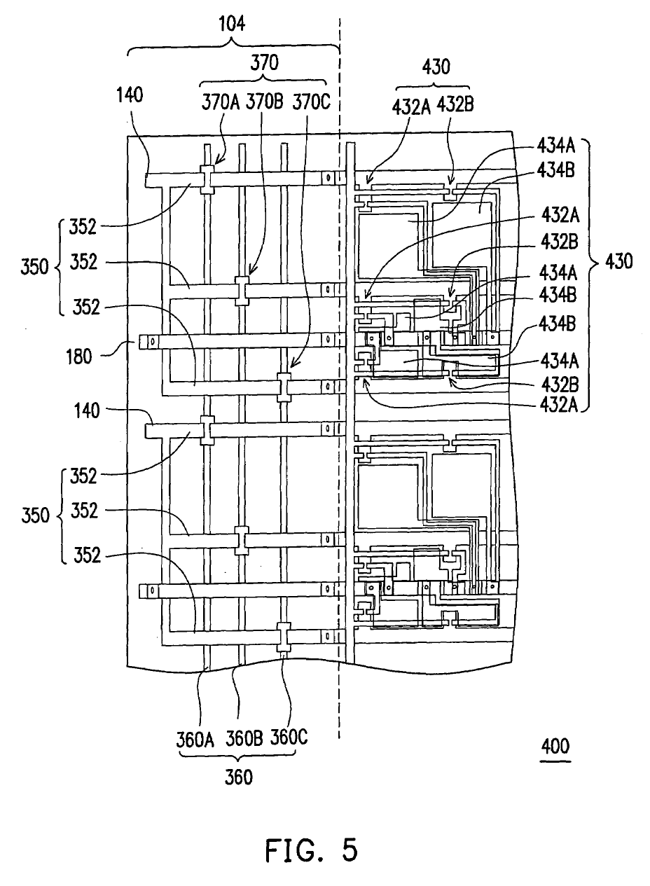

FIG. 5 illustrates an active device array substrate according to the fourth embodiment of the present invention. Referring to FIG. 5, the active device array substrate 400 is substantially the same as the active device array substrate 300, wherein each pixel unit 430 includes three first active devices 432A, three second active devices 432B, and three first pixel electrodes 434A electrically connected to the first active device 432A and three second pixel electrodes 434B electrically connected to the second active devices 432B. In other words, the pixel unit 430 is actually divided into six display areas. Each display area is constituted of an active device (432A or 432B) and a pixel electrode (434A or 434B). Each second active device 432B electrically connects the corresponding first active devices 432A, and is disposed on the same scan line 110 with the corresponding first active device 432A.

When applying the active device array substrate 400 of the present embodiment to LCD panels, each pixel unit 430 is divided into six display areas to enhance the display quality and achieve a wide-range displaying effect. In addition, each scan-signal terminal 140 in the present embodiment can control six active devices (three first active devices 432A and three second active devices 432B) in the pixel unit 430, so that the number of the driving chips used and the required cost are reduced. The circuit layout of the circuit area 104 does not become more complex because more active devices 432A and 432B are disposed.

### The Fifth Embodiment

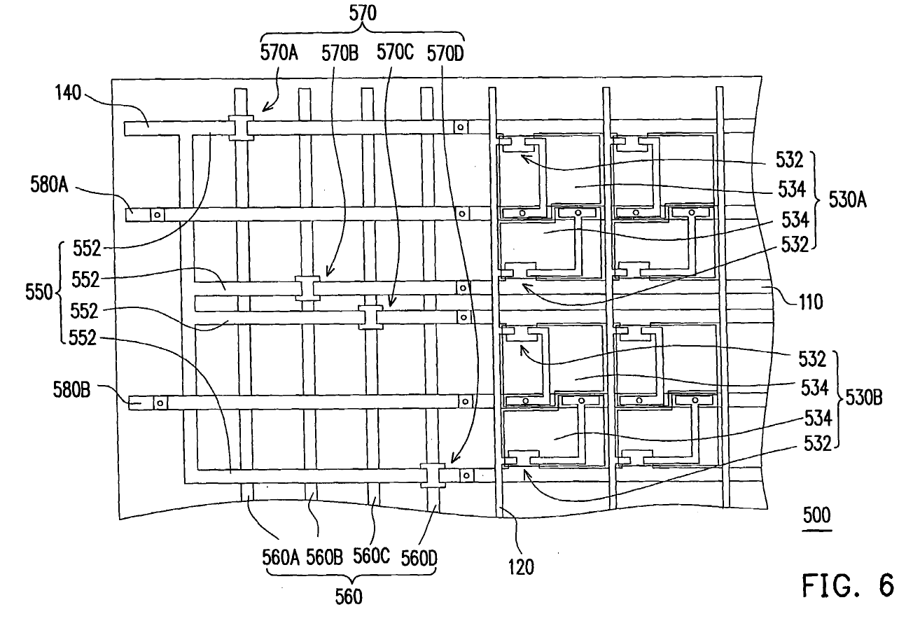

FIG. 6 illustrates an active device array substrate according to the fifth embodiment of the present invention. Referring to FIG. 6, an active device array substrate 500 is substantially the same as the active device array substrate 100, wherein the difference lies in that each scan-signal terminal 140 of the active device array substrate 500 connects four transmission lines 552. That is to say, each transmission circuit set 550 includes four transmission lines 552. One end of each scan transmission line 552 connects the scan-signal terminal 140, while the other end connects the corresponding scan line 110. Each transmission line 552 connects one controlling switch 570, and each of controlling switches 570A-570D is respectively controlled by controlling lines 560A-560D. In addition, the signal provided by each scan-signal terminal 140 can control two pixel units 530A and 530B which are connected to different scan lines 110.

Furthermore, the circuits corresponding to each scan-signal terminal 140 of the active device array substrate 500 include two common lines 580A and 580B. The common line 580A and the common line 580B respectively overlap with pixel electrodes 534 of the pixel units 530A and 530B, so as to provide capacitor effect for the pixel units 530A and 530B to have high display quality. Actually, according to the present embodiment, connecting different pixel units 530A and 530B to the same scan-signal terminal 140 helps reduce the number of driving chips required. In other words, each driving chip (not illustrated) connected to the scan-signal terminal 140 in the active device array substrate 500 of the present invention can provide scan signals to drive the pixel units 530A and 530B which are of different levels.

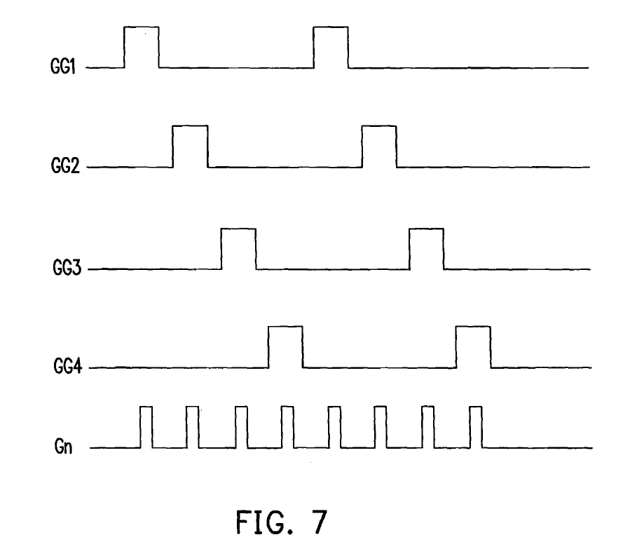

FIG. 7 is a timing diagram illustrating the method for driving the active device array substrate 500. Referring to FIG. 7, according to the present embodiment, controlling signals GG1˜GG4 do not overlap with each other in their timing, and the controlling signals GG1˜GG4 are provided correspondingly into the controlling lines 560A˜560D. Therefore, the controlling switches 570A˜570D are switched on in order, so as to input a corresponding scan signal Gn to the different scan lines 110. Therefore, each scan-signal terminal 140 controls active devices 532 on four scan lines 110. In practice, when a frequency of the controlling signals GG1˜GG4 is “f”, a frequency of the controlling signal Gn is “4f”, for example. In other embodiments, when the number of the corresponding scan lines 110 connected to scan-signal terminal 140 increases, the frequency of the scan signal Gn increases by several folds. In addition, according to the present embodiment, the number of the transmission lines 552 of the transmission circuit set 550 is, for example, the same as the number of the controlling lines 560. For instance, when each transmission circuit set 550 includes four transmission lines 552, the active device array substrate 500 is disposed with four controlling lines 560, for example. At this time, every four transmission lines 552 require only one driving chip to be disposed, so the number of the driving chips required is reduced to one-fourth of the number of the scan lines 110. Namely, with N controlling lines 560 added to the active device array substrate 500 of the present invention, the number of driving chips required is reduced to one-Nth of the number of the scan lines 110 and the cost is therefore reduced.

Based on the above, in the active device array substrate of the present invention, the transmission circuit set constituted of a plurality of transmission lines are used to connect a scan-signal terminal and a corresponding number of controlling switches are used to connect the transmission lines. The signal in the transmission lines can be transmitted to the corresponding scan lines after the corresponding controlling switches are switched on. Therefore, the number of the driving chips required for the active device array substrate of the present invention is lessened and the cost thereof is reduced. In addition, each pixel unit in the active device array substrate of the present invention is divided into a plurality of display areas. Therefore, when said active device array substrate is applied to LCD panels, the problem of color washout when viewing an image at a large viewing angle is mitigated. In other words, the active device array substrate of the present invention helps improve the display quality and reduce the manufacturing cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An active device array substrate, having a display area and a circuit area connected thereto, the active array substrate comprising:
a plurality of scan lines;
a plurality of data lines, intersected with the scan lines;
a plurality of pixel units, located in the display area and electrically connected to the corresponding data lines and scan lines;
a plurality of scan-signal terminals, located in the circuit area;
a plurality of transmission circuit sets, located in the circuit area, each of the transmission circuit sets respectively connected to the corresponding scan-signal terminal, each of the transmission circuit sets including a plurality of transmission lines corresponding to the scan lines;
a plurality of controlling lines, located in the circuit area and intersected with the transmission lines; and
a plurality of controlling switches, connected to the transmission lines respectively, wherein the controlling switches connected to the same scan-signal terminal are connected to different controlling lines.

2. The active device array substrate as claimed in claim 1, wherein each of the pixel units comprises a plurality of first active devices and a plurality of first pixel electrodes electrically connected with the first active devices, the first active devices electrically connected to one of the corresponding data lines, and electrically connected to different scan lines respectively.

3. The active device array substrate as claimed in claim 2, wherein the scan lines electrically connected to each of the pixel units are connected to the same scan-signal terminal via corresponding controlling switches.

4. The active device array substrate as claimed in claim 2, wherein each of the pixel units further comprises a plurality of second active devices and a plurality of second pixel electrodes electrically connected to the second active devices, each of the second active devices and the first active devices corresponding thereto are disposed on the same scan line and electrically coupled to the corresponding first active devices.

5. The active device array substrate as claimed in claim 1, further comprising a plurality of common lines intersected with the pixel units.

6. The active device array substrate as claimed in claim 1, wherein the transmission circuit sets comprise a first transmission circuit set and a second transmission circuit set, the number of the transmission lines in the first transmission circuit set being equal to the number of the transmission lines in the second transmission circuit set.

7. The active device array substrate as claimed in claim 6, wherein the number of the transmission lines of each of the transmission circuit sets is 2, 3 or 4.

8. The active device array substrate as claimed in claim 1, wherein the number of the transmission lines in each of the transmission circuit sets is 2, 3 or 4.

9. A method for driving the active device array substrate claimed in claim 1, comprising:
providing a plurality of controlling signals respectively to different controlling lines so as to switch on the controlling switches connected to different controlling lines; and
providing a scan signal via the scan-signal terminals to the transmission circuit set, and with the controlling switches being switched on, the scan signal is provided to different scan lines.

10. The method as claimed in claim 9, wherein the controlling signals provided to the different controlling lines are not synchronized.

11. The method as claimed in claim 9, wherein a start-up time of the scan signal is later than a start-up time of one of the controlling signals.

12. The method as claimed in claim 9, wherein an ending time of the scan signal is earlier than an ending time of one of the controlling signals.

13. The method as claimed in claim 9, wherein the scan signal overlaps with the controlling signals.

14. The method as claimed in claim 9, wherein a frequency of the controlling signals is “f”, a frequency of the scan signal is “nf”, and “n” represents a number of the transmission lines in each of the transmission circuit sets.

15. The method as claimed in claim 9, further comprising providing a plurality of data signals respectively to the data lines.
